(19) United States
(12) Patent Application Publication
(10) Pub. No.: US 2017/0232514 A1
(43) Pub. Date: Aug. 17, 2017

(54) SUPERPLASTIC FABRICATION OF SUPERALLOY COMPONENTS FOR TURBINE ENGINES

(71) Applicant: Siemens Energy, Inc., Orlando, FL (US)

(72) Inventor: Gerald J. Bruck, Titusville, FL (US)

(21) Appl. No.: 15/045,289

(22) Filed: Feb. 17, 2016

(51) Int. Cl. B22F 3/105; B22F 3/24; B22F 5/00; B22F 5/04; B23K 26/342; F01D 9/02; B33Y 10/00; B33Y 40/00; B33Y 80/00; F23R 3/42; F23R 3/28; F01D 25/04; B22F 3/15; B23K 26/70

(52) U.S. Cl. CPC B22F 3/1055; B22F 3/15; B22F 3/24; B22F 5/009; B22F 5/04; B23K 26/342; B23K 26/70; B33Y 10/00; B33Y 40/00; B33Y 80/00; F23R 3/42; F23R 3/28; F01D 25/04; F01D 9/023; B23K 2201/001

(57) ABSTRACT

Superalloy material components for turbine engines, including steam and combustion turbine engines are fabricated by superplastic formation of a laser-sintered preform. Superalloy material powder is sintered into a preform, such as by laser sintering. The preform is inserted within a pressurized forming furnace, containing a mold with a mold cavity defined by a mold cavity surface. The preform is heated in the forming furnace, and differential pressure is applied across the preform to deform it superplastically into abutting contact with the mold cavity surface, without fracturing the preform. Thereafter, the superalloy component is extracted from the forming furnace.

### TECHNICAL FIELD

The invention relates to superplastic fabrication of superalloy material components for turbine engines, including steam and combustion turbine engines. More particularly, the superalloy turbine engine components are formed by sintering superalloy material powder into a preform, such as by laser sintering. The preform is inserted within a pressurized forming furnace, containing a mold with a mold cavity. A first side of the preform is in communication with the mold cavity. The preform is heated in the forming furnace, while fluid pressure is applied and increased on a second side of the preform. The preform superplastically deforms, in abutting contact with the mold cavity surface, forming the superalloy component. The superalloy component is extracted from the mold cavity and the forming furnace.

### BACKGROUND

Application of nickel-, iron, or cobalt-based superalloy castings to gas turbines is largely limited to high value added components such as blades and vanes, due to fabrication challenges and cost. Extended application of such cast superalloy materials to other turbine components such as combustion baskets, associated resonators, pilot nozzles, and transition liners is limited by the inability to cast thin sheet or thin-walled component structures. Those high-strength superalloys are not easily formed into thin-walled components by traditional metal rolling, forging, or otherwise forming them into the precise shapes required for such aforementioned components.

Superplastic forming (“SPF”) by low strain rate, constant elevated temperature processing can shape fine-grained superalloys (such as IN-718 alloy) up to 250% without annealing. Fine grain structure in the range of American Society for Testing Materials (“ASTM”) grain size 10 to 13 is required for slippage of grain boundaries at low flow stress and strain deformation without fracture. Most cast or wrought materials have too large grain size to permit such processing. The fine grain structure in the ASTM grain size 10 to 13 can be achieved by precipitations in some alloys (e.g., heat treatment to precipitate delta phase needles in IN-718 alloy). Only a limited number of superalloys can benefit from precipitations to achieve fine microstructure. In addition to delta processing of alloy IN-718, it is possible to precipitate eta phase in alloy 901 and alloy A-286. However, many other superalloy material starter shapes needed for fabrication of turbine engine components must be made by powder metallurgy as the precursor to superplastic forming. Fine grain structure in the ASTM grain size 10 to 13 can be achieved by powder metallurgy processing (e.g. hot isostatic pressing or extrusion consolidation starting with powder). Conventional superalloy powder metallurgy processing is expensive, and of limited flexibility to provide useful SPF-precursor, starter shapes needed to form the relatively thin-walled, precise shapes of the aforementioned combustion baskets, associated resonators, pilot nozzles, and transition liners for turbine engines.

### SUMMARY OF INVENTION

In exemplary embodiments described herein, superalloy material components for turbine engines, including steam and combustion turbine engines are fabricated by superplastic formation of a laser-sintered preform. Superalloy material powder is sintered into a preform, such as by an additive manufacturing process known as selective laser sintering (“SLS”), which in some embodiments exhibit a desired ASTM grain size 10 to 13. In some embodiments, the average grain size of the superalloy powder, prior to sintering, is 4 to 11 microns (μ). The preform is inserted within a pressurized forming furnace, containing a mold with a mold cavity defined by a mold cavity surface. The preform is heated in the forming furnace, and differential pressure is applied across the preform to deform it superplastically into abutting contact with the mold cavity surface, without fracturing the preform. The superalloy component is extracted from the forming furnace. In some embodiments, a first side of the preform is in communication with the mold cavity, while a second side of the preform is in communication with a pressurized fluid source. The preform is heated in the forming furnace, while fluid pressure is increased on the second side of the preform. The preform superplastically deforms, in abutting contact with the mold cavity surface, analogous to blow-molding polymer material into a bottle or other thin-walled vessel, forming the superalloy component. The superalloy component is extracted from the mold cavity and the forming furnace.

In some embodiments, the superalloy powder is a nickel-based superalloy powder (e.g., commercially available alloy powders sold under the designations Haynes 282, 263; Rene 41, 80; N4; Inconel 738, 939; CMSX 4, 6, 10; CM 247; PWA 1480, 1484) while in other embodiments, other powder material is used in the powder mixture to sinter the preform, such as iron (e.g., commercially available alloy powders sold under the designations A286; Incoloy 909, 925) or cobalt (e.g., commercially available alloy powders sold under the designations Haynes 25, 188; MarM 918) based superalloys, other element based alloys (e.g. titanium based alloys (e.g., Ti-6Al-4V, Ti-6Al-2Sn-4Zr-2Mo)), ceramics (e.g. silica, zirconia, alumina), oxide dispersion-strengthened material (e.g., commercially available ceramic powders sold under the designations MA758, 956), glasses (e.g. borosilicate, soda-lime silicate, phosphate) and polymers (e.g., silicone rubber, polyethylene terephthalate (PET), polyethylene succinate (PES), polyether ether ketone (PEEK)). In some embodiments, the selected powders used to form the preform are mixed with other structures, such as carbon fibers, or metals plus ceramics, during the sintering stage to produce composite preforms that are in turn superplastically formed into turbine engine components.

In some embodiments, powder material is preheated prior to laser sintering, in order to enhance particle sintering. In some embodiments, subsequent to laser sintering of the powder into the preform and its superplastic formation, various processes are performed, jointly or severally in any combination, on the preform. Post SPF processes include by way of example: heat treating the preform to enhance grain size and properties; diffusion bonding of a plurality of preforms, in order to fabricate composite components; hot isostatic pressing, in order to densify or modify grain microstructure within the component; machining; coating, and/or inspecting the preform.

Exemplary embodiments of the invention feature methods for forming superalloy components for turbine engines. Superalloy powder is sintered, by an additive manufacture, selective sintering process into a preform having first and second sides. The preform is inserted into a heated, pressurized forming furnace, which includes therein a mold with a mold cavity defined, by a mold cavity surface, and a chamber in communication with a pressurized fluid source, such as a pressurized inert gas source. The preform is heated in the forming furnace, and differential pressure is applied across the preform to deform it superplastically into abutting contact with the mold cavity surface, without fracturing the preform. The superalloy component is extracted from the forming furnace. In some embodiments, during the forming furnace insertion the preform's first side is in communication with the mold cavity, while the preform's second side is in communication with the chamber and pressurized fluid source. The preform is heated in the furnace. Increasing pressure is applied on the preform second side, with pressurized fluid from the pressurized fluid source. The preform is superplastically deformed in response to the increasing pressure, without fracturing the preform. Pressure is ceased on the preform second side after the preform first side is in abutting contact with the mold cavity surface, forming the superalloy component. Thereafter, the superalloy component is extracted from the forming furnace. In some embodiments, the heated preform surrounds a mold shape, and a differential pressure is applied to collapse the preform into the shape of the mold surface. Such collapsing differential pressure is generated by a vacuum generated between the mold surface and the inboard side of the preform, or an elevated pressure is applied outboard of the preform. This collapsing differential pressure approach is akin to using vacuum or external pressure to seal a storage bag tightly around an object—with the “bag” being a superalloy preform and “object” being the mold, with the process being conducted in a forming furnace.

Other exemplary embodiments of the invention feature methods for forming superalloy components for turbine engines by selective laser sintering (“SLS”) superalloy powder into a preform having first and second sides, without causing solidification cracking or reheat cracking in the preform. A heated, pressurized forming furnace is provided, which includes therein a mold with a mold cavity defined by a mold cavity surface, and a chamber in communication with a pressurized fluid source. The preform is heated in the forming furnace, and differential pressure is applied across the preform to deform it superplastically into abutting contact with the mold cavity surface, without fracturing the preform. The superalloy component is extracted from the forming furnace. In some embodiments, the preform is inserted into the forming furnace, with the preform first side in communication with the mold cavity and the preform second side in communication with the chamber and pressurized fluid source. The preform is heated in the furnace, below melting temperature of the preform material. Increasing pressure is applied on the preform second side with pressurized fluid from the pressurized fluid source, superplastically deforming the preform in response to the increasing pressure, without fracturing the preform. Pressure on the preform second side ceases after the preform first side is in abutting contact with the mold cavity surface, forming the superalloy component. The superalloy component is extracted from the forming furnace. In some embodiments the pressure differential across the preform is generated by decreasing pressure between the preform first side and the mold cavity surface, which in turn causes relative increased pressure of the pressurized fluid on the preform second side to deform the preform.

Additional exemplary embodiments feature a method for forming superalloy components for turbine engines, by selective laser sintering (“SLS”) superalloy powder into a preform having first and second sides, without causing solidification cracking or reheat cracking in the preform. A heated, pressurized forming furnace, is provided, which includes therein a mold with a mold cavity defined by a mold cavity surface, and a chamber in communication with a pressurized fluid source. The preform is inserted into the forming furnace, with the preform first side in communication with the mold cavity and the preform second side in communication with the chamber and pressurized fluid source. The preform is heated in the furnace to a temperature between approximately 900 to 1100 degrees Celsius, below melting temperature of the preform material. Increasing pressure is applied on the preform second side, with pressurized fluid from the pressurized fluid source. The pressure is increased, in order to deform the preform superplastically in response to the increasing pressure, to achieve strain rates in the range of approximately 0.02 to 1.0 per minute, without fracturing the preform. Pressure application is ceased on the preform second side, after the preform first side is in abutting contact with the mold cavity surface, which forms the superalloy component. The superalloy component is extracted from the forming furnace.

The respective features of the exemplary embodiments of the invention that are described herein may be applied jointly or severally in any combination or sub-combination.

### BRIEF DESCRIPTION OF DRAWINGS

The exemplary embodiments of the invention are further described in the following detailed description in conjunction with the accompanying drawings, in which:

FIG. 1 is a partial axial cross sectional view of a gas or combustion turbine engine, incorporating one or more superalloy components, formed in accordance with exemplary method embodiments of the invention;

FIG. 2 is a detailed cross sectional elevational view of the turbine engine of FIG. 1, showing a combustor section, which incorporates one or more superalloy components, formed in accordance with exemplary method embodiments of the invention;

FIG. 3 is a plan view of a laser sintered preform, which is used to form superalloy components, in accordance with exemplary method embodiments of the invention;

FIG. 4 is a detailed plan view of exemplary sintered, superalloy powder, which forms the sintered preform of FIG. 3;

FIG. 5 is a cross sectional, schematic elevational view of a pressurized forming furnace, including a mold defining a mold cavity surface, with the preform of FIG. 3 in communication with the mold cavity, prior to deforming the preform;

FIG. 6 is a cross sectional, schematic elevational view of the pressurized forming furnace of FIG. 5, after superplastic formation of the turbine engine component;

FIG. 7 is a cross sectional, elevational view of the cup shaped, superplastic formed, turbine engine component of FIG. 6, after extraction from the pressurized forming furnace;

FIG. 8 is an elevational view of a cylindrical-shaped, laser sintered preform, which is used to form superalloy components, in accordance with exemplary method embodiments of the invention;

FIG. 9 is a plan view of the cylindrical-shaped, laser sintered preform of FIG. 8;

FIG. 10 is detailed cross sectional view of exemplary sintered, superalloy powder, which forms the sintered preform of FIGS. 8 and 9;

FIG. 11 is a cross sectional, schematic elevational view of a pressurized forming furnace, including a mold defining a mold cavity surface for a bellows shaped superalloy component, with the cylindrical shaped preform of FIGS. 8-10 in communication with the mold cavity, prior to deforming the preform; and

FIG. 12 is a cross sectional, elevational view of the superplastic formed, bellows shaped turbine engine component of FIG. 11, after extraction from the pressurized forming furnace.

To facilitate understanding, identical reference numerals have been used, where possible, to designate identical elements that are common to the figures. The figures are not drawn to scale.

### DESCRIPTION OF EMBODIMENTS

In exemplary embodiments described herein, superalloy material components for combustion turbine engines, such as combustion baskets, associated resonators, pilot nozzles, main nozzles, and transition liners, are fabricated by superplastic formation of a laser-sintered preform. Such sintering of custom shape is accomplished by an additive manufacturing process, such as by selective laser sintering (“SLS”). Superalloy material powder is sintered into a preform, such as by laser sintering. The preform is inserted within a pressurized forming furnace, containing a mold with a mold cavity defined by a mold cavity surface. The preform is heated in the forming furnace, and differential pressure is applied across the preform to deform it superplastically into abutting contact with the mold cavity surface, without fracturing the preform. Thereafter, the superalloy component is extracted from the forming furnace. In some embodiments, a first side of the preform is in communication with the mold cavity, while a second side of the preform is in communication with a pressurized fluid source, such as an inert gas. The preform is heated in the forming furnace, while fluid pressure is increased on the second side of the preform. The preform superplastically deforms in response to the increasing fluid pressure, without fracturing, until it is in abutting contact with the mold cavity surface, forming the superalloy component. The preform's superplastic deformation process, within the mold cavity, is analogous to blow-molding polymer material into a bottle or other thin-walled vessel. In some embodiments, the pressure differential across the preform is generated by decreasing pressure between the preform first side and the mold cavity surface, which in turn causes relative increased pressure of the pressurized fluid on the preform second side to deform the preform. This collapsing differential pressure approach is akin to using vacuum or external pressure to seal a storage bag tightly around an object—with the “bag” being a superalloy preform and “object” being the mold, with the process being conducted in a forming furnace. After superplastic deformation, the superalloy component is extracted from the mold cavity and the forming furnace. While exemplary embodiments of the invention are used to fabricate superalloy components for combustion turbine engines, the same methods are applicable for fabrication of superalloy components for steam turbine engines.

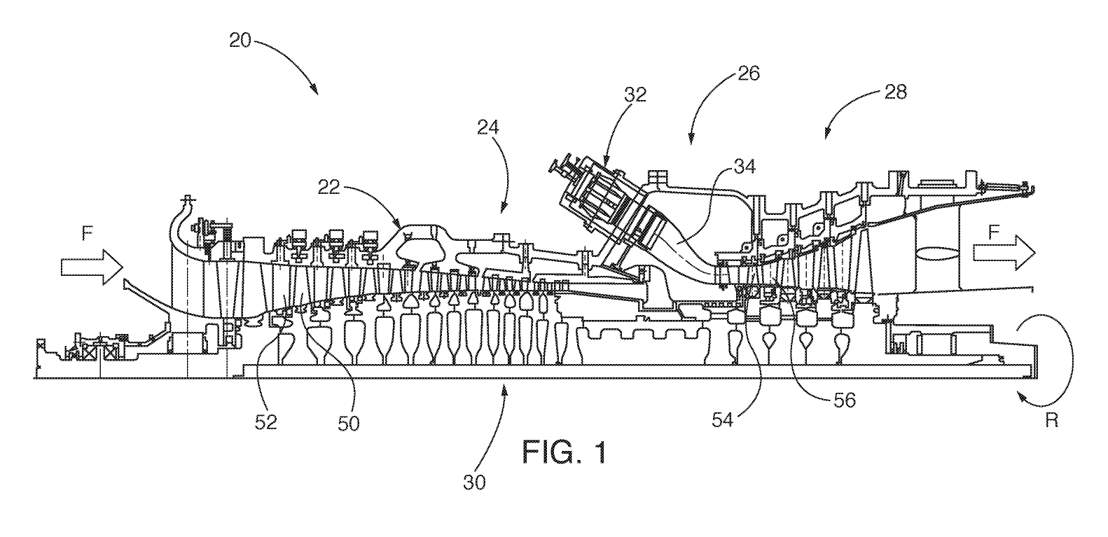

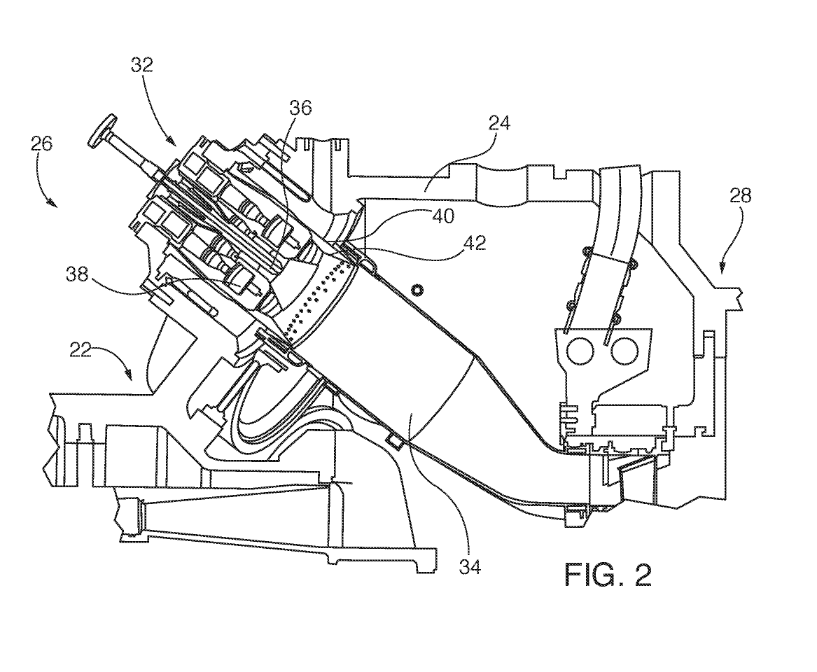

FIGS. 1 and 2 show a gas turbine engine 20, having a gas turbine casing 22, a multi-stage compressor section 24, a combustion section 26, a multi-stage turbine section 28 and a rotor 30. One of a plurality of basket-type combustors 32 is coupled to a downstream transition 34 that directs combustion gasses from the combustor to the turbine section 28. As shown in detail in FIG. 2, the combustor 32 has a known pilot nozzle 36 and a plurality of circumferentially arrayed main nozzles 38 within a combustor basket 40. The combustor basket distal downstream end 42 interfaces with the transition 34. Atmospheric pressure intake air is drawn into the compressor section 24 generally in the direction of the flow arrows F along the axial length of the turbine engine 20. The intake air is progressively pressurized in the compressor section 24 by rows rotating compressor blades 50 and directed by mating compressor vanes 52 to the combustion section 26, where it is mixed with fuel and ignited. The ignited fuel/air mixture, now under greater pressure and velocity than the original intake air, is directed through a transition 34 to the sequential blade rows in the turbine section 28. The engine's rotor 30 and shaft has a plurality of rows of airfoil cross sectional shaped turbine blades 54 and vanes 56.

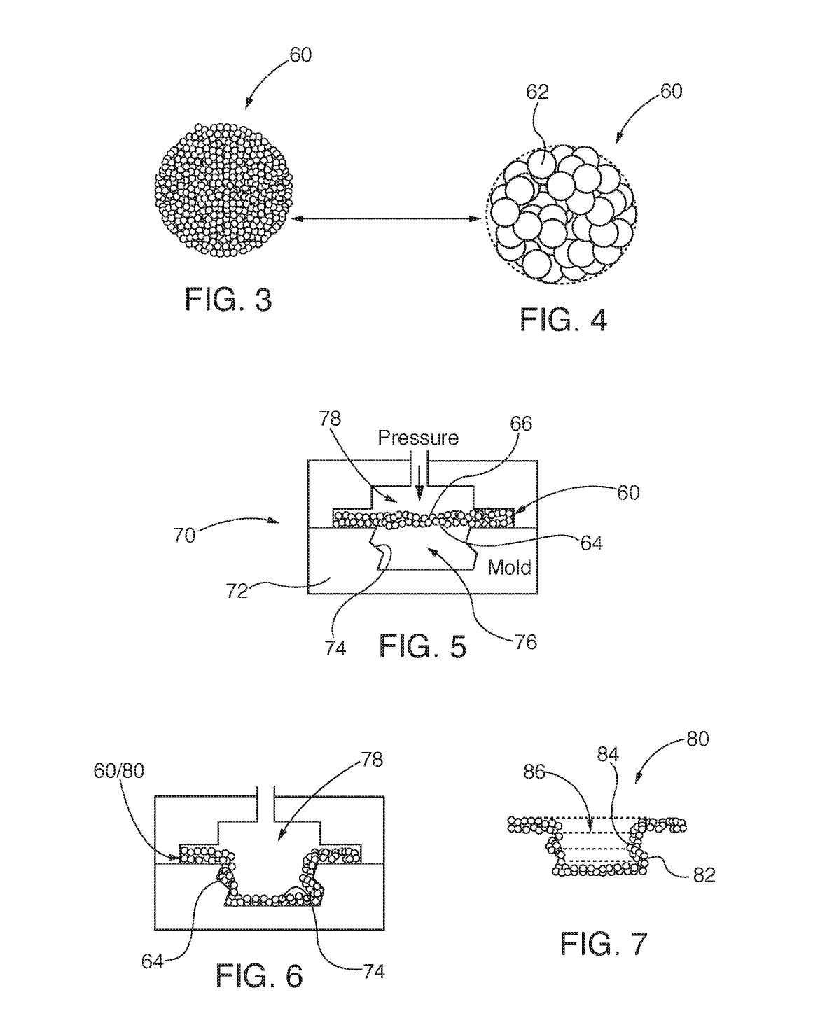

FIGS. 3 and 4 show a flat, coin-like, sintered preform 60, comprising superalloy powder material 62. In some embodiments, the superalloy powder 62 is a nickel-based superalloy powder, while in other embodiments, other powder material is used in the powder mixture sintered to form the preform 60, such as iron or cobalt based superalloys, other element based alloys, (e.g. titanium based alloys), ceramics, oxide dispersion-strengthened material, glasses and polymers. In some embodiments, the selected powders 62 used to form the preform 60 are mixed with other structures, such as carbon fibers, or metals plus ceramics, during the sintering stage, to produce composite preforms that are in turn superplastically formed into turbine engine components. Preform 60 thickness is a function of the desired superalloy component thickness. Generally, superalloy turbine components to be fabricated by the methods herein have finished wall thicknesses of between approximately 0.5 to 12 millimeters. In some embodiments, the average grain size of the superalloy powder, prior to sintering, is 4 to 11 microns (μ). In some embodiments, the superalloy powder material is preheated prior to sintering, in order to enhance particle sintering.

The superalloy material powder 62 is sintered into the preform 60, such as by laser sintering. In some embodiments, selective laser sintering (“SLS”) or direct metal laser sintering (“DMLS”) is performed, to provide sufficiently fine grain size for the preform 60, so that it plastically deforms without fracturing, during subsequent shaping operations. In some embodiments, when employing superalloy powder with average pre-sintered grain size diameter of 4-11μ, the laser sintered preform 60 exhibits a desired post-sintered grain structure of ASTM grain size of 10 to 13, which facilitates slippage of grain boundaries at low flow stress and strain deformation without undesired fracture within the preform. Selective laser melting (“SLM”) can be utilized to form the preform 60 from small size powder, however, typical melt layers in SLM are about 20μ thick. The minimum approximately 20 micron thickness per-built up layer limitation has a fully melted structure, with grain solidification building epitaxially on the underlying substrate in a manner that tends to extend underlying grains in a columnar or elongated fashion. The columnar-like grains lengthen in each subsequent melt layer, which may then greatly exceed desired maximum grain size in the completed preform. As noted above, larger grain sizes increase potential risk of fracture in the preform during the superplastic forming of the component.

In some embodiments, subsequent to laser sintering of the powder into the preform 60, and prior to the superplastic formation various processes are performed, jointly or severally in any combination, on the preform, in order to prepare it for SPF into the finished engine component. For example, selective laser sintering, or other employed methods to form the preform 60 may or may not achieve sufficient material density between the powder particles. In some embodiments, intermediate hot isostatic pressing (“HIP”) operation may be used to increase the preform 60 density prior to SPF. HIP applies high pressure in all directions on the preform 60, to densify the sintered powder particles 62. Prior to the HIP process, the preform is packaged or encapsulated, so that pressure does not pass through the preform 60 without increasing particle densification. An external, HIP package can be utilized to encapsulate the preform 60. Alternatively, the preform 60 can be self-encapsulated by forming a melted skin on the preform during or subsequent to the SLS process.

In FIG. 5, the preform 60 is inserted within a pressurized forming furnace 70, containing a mold 72 with a mold cavity surface 74 defining a mold cavity 76. A first side 64 of the preform 60 is in communication with the mold cavity 76, while a second side 66 of the preform is in communication with a chamber 78. The chamber 78 is in communication with a pressurized fluid source, such as an inert gas or other fluid. The forming furnace 70 and preform 60 is isolated from ambient air, and is selectively heated. The heat application, along with differential pressure in the chamber 78 causes superplastic deformation of the preform 60, without fracturing the preform. More specifically, in some embodiments, the preform 60 is heated in the forming furnace 70 in a temperature range of 900 to 1100 degrees Celsius, which is below the preform's constituent superalloy melt temperature, while pressure is increased on the second side 66 of the preform. In some embodiments, differential pressure increase is controlled to achieve strain rates in the range of 0.02 to 1.0 per minute. Differential pressure increase rate, preform temperature and preform thickness are balanced to avoid preform fracture during the preform deformation cycle. The preform 60 superplastically deforms, until its first surface 64 is in abutting contact with the mold cavity surface 74, forming the superalloy component 80, which is analogous to blow molding a polymer material bottle. In FIG. 7, the superalloy component 80, (for example a combustion basket 40, pilot nozzle 36, main nozzle 38, transition liner of transition 34, shown in FIGS. 1; and 2, or a combustion basket resonator), is extracted from the mold cavity 76 and the forming furnace 70.

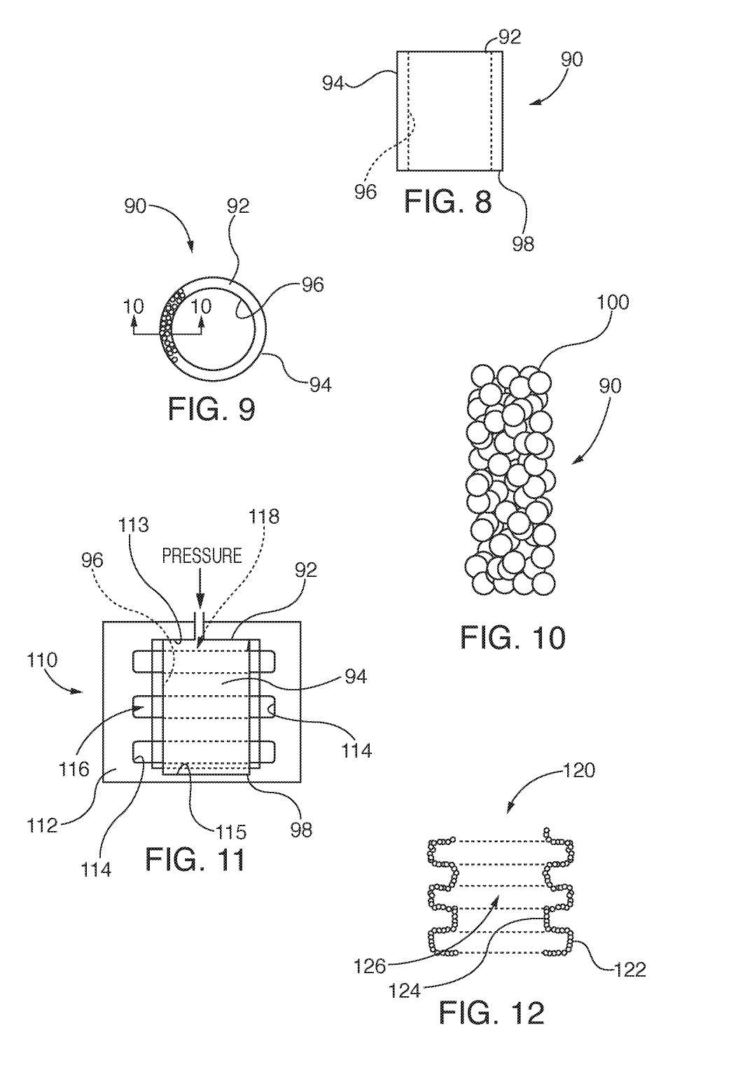

Another exemplary embodiment of turbine component fabrication is shown in FIGS. 8-12, which is used to form a bellows shaped superalloy component 120. Here, in FIGS. 8-10, the laser sintered preform 90 is fabricated as cylinder having a first or upper axial face 92, a first, outer, circumferential surface 94, a second, inner, circumferential surface 96, and a second or lower axial face 98. In one embodiment, the preform 90 is fabricated by selective laser sintering or other type of sintering (e.g. vacuum furnace, spark plasma, electron beam), of the superalloy powder particles 100. The particles 100 may comprise any of the constituent materials, other additional structures, particle size range of 4-11μ, and sintered grain size, size ASTM 10-13, previously identified with respect to the preform 60.

The forming furnace 110 of FIG. 11 has the same basic structure and operation as forming furnace 70 of FIG. 5, with a split or clamshell mold 112 configuration that is separated from the second, exterior surface 122 of the finished component 120 after fabrication. The mold 112 has a first or upper axial surface 113, an inner circumferential surface 114, and a bottom or second axial surface 115 that define a mold cavity 116. The clamshell mold 112 is separated; thereafter the preform 90 is inserted into the mold cavity 116, with its first axial face 92 in contact with the first axial surface 113 of the mold and its second axial face 98 in contact with the second axial surface 115 of the mold. The preform 90 first, outer circumferential surface 94 is in opposed relationship with the mold circumferential surface 114, separated by the mold gap 116. The preform 90 second, inner circumferential surface 96 is in communication with a chamber 118 and a pressurized fluid source, such as a pressurized inert gas.

The forming furnace 110 and preform 90 are isolated from ambient air, and the furnace is selectively heated, in order to heat the preform 90. Heat, along with differential pressure applied within the chamber 118 cause superplastic deformation within the preform 90. More specifically, the preform 90 is heated in the forming furnace 110 below the preform's constituent superalloy melt temperature, while pressure is increased on the second side 96 of the preform. The preform 90 superplastically deforms, until its cylindrical first or outer surface 94 is in abutting contact with the mold cavity surface 114, forming the superalloy component 120, which is analogous to blow molding a polymer material bottle. The exemplary superalloy component 120 is a bellows component, for use within a turbine engine. After the SPF process is completed, the clamshell mold 112 segments are separated from the component 120. The component has an outer surface 122, an inner surface 124, and an internal cavity 126, which in this embodiment is open at both axial ends.

Turbine engine components fabricated in accordance with the exemplary methods of this invention are superplastically deformed without fracturing the preform during heating and application of the pressure differential. Preform fracture is avoided by balancing differential pressure increase rate, preform temperature, as well as any or all of preform constituent material composition, thickness and grain size, during the preform deformation cycle. Preform thickness is a function of the desired finished component thickness, which for turbine engine components is generally in the range of 0.5 to 12 millimeters. Preform grain size is influenced by average particle size of the alloy powder mixture used to fabricate the preform and any HIP or other grain densification processes applied to the preform. In some embodiments the preform heating temperature range is between approximately 900 to 1100 degrees Celsius and differential pressure increase is controlled to achieve strain rates in the range of 0.02 to 1.0 per minute.

After turbine engine component SPF process is completed, the component 80 or 120 is available for further fabrication processes. Exemplary post SPF processes include any one or more of heat treatment to enhance grain size and properties; diffusion bonding of a plurality of preforms, in order to fabricate composite components; hot isostatic pressing, in order to modify grain structure and increase component density; machining; coating; and/or inspection to confirm component conformity with design specifications. Exemplary heat treatments are chosen to optimize final component part properties and microstructure (e.g. grain size, carbides, gamma prime precipitation). For example, solution and double age hardening is widely applied as a final process step for optimizing material properties of nickel-based superalloys.

Finished turbine engine components, produced by the sintering and SPF process embodiments described herein, exhibit fine grain structure, and likely better fatigue strength than a comparable superalloy component that is manufactured through a selective laser melting (“SLM”) process or a general investment-casting process. As previously discussed, superalloy castings do not exhibit the small grain sizes or ability to form thin walled structures comparable to the present sintering/SPF processes. While it is possible to fabricate thin walled structures, using SLM, those components are more susceptible to solidification cracking during formation and reheat cracking during subsequent heat treatment. Both solidification and reheat cracking propensities are avoided in components produced by the sintering and SPF process embodiments described herein.

Although various embodiments that incorporate the invention have been shown and described in detail herein, others can readily devise many other varied embodiments that still incorporate the claimed invention. For example, the preform can be constructed in a flat, planar shape, a cylindrical shape, or any other three-dimensional shape that facilitates application of differential pressure on the preform, so that it is superplastically formed into contact with the forming furnace mold surface, in a fashion analogous to that of plastic blow molding bottles or other vessels.

The invention is not limited in its application to the exemplary embodiment details of construction and the arrangement of components set forth in the description or illustrated in the drawings. The invention is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted”, “connected”, “supported”, and “coupled” and variations thereof are used broadly and encompass direct and indirect mountings, connections, supports, and couplings. Further, “connected” and “coupled” are not restricted to physical, mechanical, or electrical connections or couplings.

What is claimed is:

1. A method for forming superalloy components for turbine engines, comprising:
additive manufacture, selective sintering of superalloy powder into a preform having first and second sides;
providing a heated, pressurized forming furnace, including therein a mold with a mold cavity defined by a mold cavity surface, and a chamber in communication with a pressurized fluid source;
inserting the preform into the forming furnace, with the preform first side in communication with the mold cavity and the preform second side in communication with the chamber and pressurized fluid source;
heating the preform in the furnace;
applying increasing pressure on the preform second side with pressurized fluid from the pressurized fluid source, superplastically deforming the preform in response to the increasing pressure, without fracturing the preform;
ceasing pressure on the preform second side after the preform first side is in abutting contact with the mold cavity surface, forming the superalloy component; and
extracting the superalloy component from the forming furnace.

2. The method of claim 1, further comprising hot isostatic pressing (“HIP”) the preform after sintering and before insertion into the forming furnace.

3. The method of claim 2, further comprising encapsulating the preform before the HIP, within an external package or by melting exterior surfaces of the preform to form a solid skin layer thereon.

4. The method of claim 1, the superalloy powder having an average pre-sintered grain size of 4 to 11 microns in diameter.

5. The method of claim 1, the superalloy powder comprising nickel, iron, or cobalt based superalloys.

6. The method of claim 1, the superalloy powder comprising any one or more of titanium alloy, ceramics, oxide dispersion strengthened material, glass, or polymer.

7. The method of claim 1, the preform additive-manufacture sintering performed by selective laser sintering (“SLS”), or by direct metal laser sintering (“DMLS”), or by selective laser melting (“SLM”).

8. The method of claim 1, the sintered preform comprising a sintered grain size of ASTM grain size 10 to 13, prior to insertion within the forming furnace.

9. The method of claim 1, the mold comprising a clamshell, split mold.

10. The method of claim 1, the preform comprising a planar or three-dimensional shape.

11. A method for forming superalloy components for turbine engines, comprising:
selective laser sintering (“SLS”) superalloy powder into a preform having first and second sides, without causing solidification cracking or reheat cracking in the preform;
providing a heated, pressurized forming furnace, including therein a mold with a mold cavity defined by a mold cavity surface, and a chamber in communication with a pressurized fluid source;
inserting the preform into the forming furnace, with the preform first side in communication with the mold cavity and the preform second side in communication with the chamber and pressurized fluid source;
heating the preform in the furnace, below melting temperature of the preform material;
applying increasing pressure on the preform second side with pressurized fluid from the pressurized fluid source, superplastically deforming the preform in response to the increasing pressure, without fracturing the preform;
ceasing pressure on the preform second side after the preform first side is in abutting contact with the mold cavity surface, forming the superalloy component; and
extracting the superalloy component from the forming furnace.

12. The method of claim 11, the superalloy powder having a pre-sintering average grain size of between 4 to 11 microns in diameter and the sintered preform comprising a sintered grain size of ASTM grain size 10 to 13, prior to insertion within the forming furnace.

13. The method of claim 11, further comprising hot isostatic pressing (“HIP”) the preform after sintering and before insertion into the forming furnace.

14. The method of claim 13, further comprising encapsulating the preform before the HIP, by melting exterior surfaces of the preform during the SLS, to form a solid skin layer thereon.

15. A method for forming superalloy components for turbine engines, comprising:
selective laser sintering (“SLS”) superalloy powder into a preform having first and second sides, without causing solidification cracking or reheat cracking in the preform;
providing a heated, pressurized forming furnace, including therein a mold with a mold cavity defined by a mold cavity surface, and a chamber in communication with a pressurized fluid source;
inserting the preform into the forming furnace, with the preform first side in communication with the mold cavity and the preform second side in communication with the chamber and pressurized fluid source;
heating the preform in the furnace to a temperature between approximately 900 to 1100 degrees Celsius, below melting temperature of the preform material;
applying increasing pressure on the preform second side with pressurized fluid from the pressurized fluid source, superplastically deforming the preform in response to the increasing pressure to achieve strain rates in the range of approximately 0.02 to 1.0 per minute, without fracturing the preform;
ceasing pressure on the preform second side after the preform first side is in abutting contact with the mold cavity surface, forming the superalloy component; and
extracting the superalloy component from the forming furnace.

16. The method of claim 15, the superalloy powder forming the preform having a pre-sintering average grain size of between 4 to 11 microns in diameter; and the sintered preform comprising a sintered grain size of ASTM grain size 10 to 13, and a thickness of between approximately 0.5 to 12 millimeters, prior to insertion within the forming furnace.

17. The method of claim 15, further comprising hot isostatic pressing (“HIP”) the preform after sintering and before insertion into the forming furnace.

18. The method of claim 17, further comprising encapsulating the preform before the HIP, by melting exterior surfaces of the preform during the SLS, to form a solid skin layer thereon.

19. The method of claim 15, further comprising heat treating the superalloy component after its extraction from the forming furnace.
